(19) United States
(12) Patent Application Publication
(10) Pub. No.: US 2003/0166445 A1
(43) Pub. Date: Sep. 4, 2003

(54) Rotatable chamber for separating blood or plasma components

(76) Inventor: Jean-Denis Rochat, Genolier (CH)

Correspondence Address: STURM & FIX LLP, 206 SIXTH AVENUE, SUITE 1213, DES MOINES, IA, 50309-4076, US

(21) Appl. No.: 10/379,865

(22) Filed: Mar. 4, 2003

Related U.S. Application Data
(63) Continuation of application No. PCT/IB01/01571, filed on Aug. 30, 2001.

(30) Foreign Application Priority Data
Sep. 5, 2000 (EP) 00810799.7

(51) Int. Cl. B04B 7/08

(52) U.S. Cl. 494/45

(57) ABSTRACT

A channel (10) follows a generally concave curve with respect to the axis of rotation (2) of the chamber (1), alongside which is located a feed opening (7) for blood and at least two openings (8, 9) for evacuating separated components. Rotation of the chamber can apply radial forces to the blood to be separated to cause solid particles to sediment against the outer lateral wall of said channel (10). This lateral wall is shaped to produce a plurality of adjacent recesses (16, 24, 33) that are successive in the direction (F) of blood flow to be separated, the wall connecting the bottom of each recess (16, 24, 33) to its downstream end with respect to the direction (F) has an angular extent with respect to the axis of rotation (2, 28) of the rotatable chamber (1) that is set, and the distance between this wall and this axis of rotation (2, 28) reduces gradually from the bottom of said recess to its downstream end.

The present invention relates to a rotatable chamber for separating components with different densities and/or sizes from blood or platelet-rich plasma, comprising a channel following a curve that is generally concave with respect to the axis of rotation of said chamber, alongside which are located an opening for feeding blood or plasma and at least two openings for evacuating said separated components, means for applying a tangential force to the blood or plasma to cause it to move from the feed opening to the evacuation openings, and means for driving said chamber in rotation in order to apply a radial force to the blood or plasma to be separated to cause said solid particles to sediment out against the outer lateral wall of said channel.

Many solutions have been proposed to allow continuous separation of blood with a view to extracting platelets for administration to a patient, returning the plasma, red blood cells and white blood cells to the donor.

The disadvantages of the proposed solutions stem from the fact that, to achieve acceptable platelet purity, the machines produced are bulky, expensive and slow.

European patent applications EP-99 810294.1 and EP-99 810295.8 propose solutions intended to reduce the bulk of the machines and increase the separation rate without, however, improving the purity of the platelets separated from the blood.

The present invention aims to improve the purity of the platelets obtained with a device with a low bulk, which is sufficiently light to be transportable, relatively inexpensive both as regards the machine itself and the consumables, and which can treat blood at a relatively high speed.

To this end, the present invention provides a rotatable chamber for continuously separating components with different sizes and/or densities from blood or platelet-rich plasma, as defined in claim 1.

The separation chamber in accordance with the invention is shaped to exploit the difference in the trajectory imparted to solid particles with different densities, but above all with different sizes, resulting from the combination of radial centrifugal forces induced by the rotation imparted to the separation chamber and the tangential force imparted by the flow of platelet-rich plasma into the separation channel that is generally concave with respect to the center of rotation of the separation chamber.

While the densities of platelets, white blood cells and plasma are very close, respectively 1.040 kg/dm³, 1.070 kg/dm³ and 1.029 kg/dm³, platelets (PLT) and white blood cells (WBC) differ substantially in size since they have diameters of between 1-4 μm and 7-15 μm respectively. In the formula for the rate of sedimentation of spherical particles, the particle radius is squared. Because of this formula for the rate of sedimentation Vs, it is far more advantageous to exploit this difference in particle sizes than the density difference:

Vs÷(ρₚₐᵣₜ−ρ_{liq})r².ω²R

in which:

ρₚₐᵣₜ=particle density

ρ_{liq}=plasma density

r=particle radius

ω²R=centrifugal force, dependent on the rotational speed and the radius of the centrifugation channel.

Since the centrifugation speed is combined with a tangential force resulting from the plasma flow in the centrifugation channel, the respective trajectories of particles with substantially different sizes will also be very different. Small platelets will thus have much longer trajectories, influenced by the tangential component, while substantially larger white blood cells have shorter trajectories, being more influenced by the radial component.

As a result, by forming a series of successive recesses in the outer lateral wall of the separation channel and by proportioning and shaping these recesses in a suitable manner, in particular by selecting the angular pitch of these recesses as a function of the respective trajectories of the particles to be separated, the white blood cells with trajectories that are shorter than platelets will be trapped while the vast majority of the platelets, with longer trajectories, will pass in front of the recesses or, in the worst case, will pass from one recess to another without becoming trapped or becoming trapped only in the last recesses.

The platelet-rich plasma considered here results from initial separation of whole blood (WB). During such separation, the vast majority of the white blood cells is separated from the blood along with the red blood cells (RBC), and only the smallest and lightest white blood cells remain in the platelet-rich plasma (PRP). Taking this observation into account and knowing that the volume of white blood cells in whole blood is ten times lower than that of the platelets to be extracted from the platelet-rich plasma, it is entirely possible to design a separation chamber in accordance with the present invention, in which the total volume of the successive recesses provided in the outer lateral wall of the separation channel is suitable for storing the small volume of white blood cells remaining in the platelet-rich plasma compared with the volume of blood to be treated, which is a function of the volume of blood that can be withdrawn from the donor during a single donating session and which thus corresponds to a known volume.

The accompanying drawing illustrates diagrammatically and by way of example, a variety of embodiments of the rotatable centrifugation chamber of the present invention.

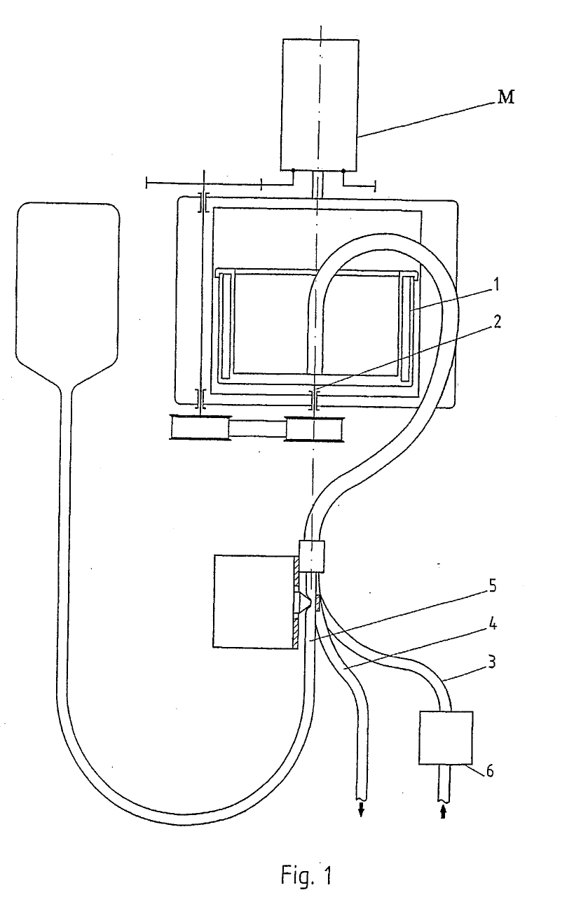

FIG. 1 shows a general diagram of a centrifuge designed for the rotatable centrifugation chamber of the invention;

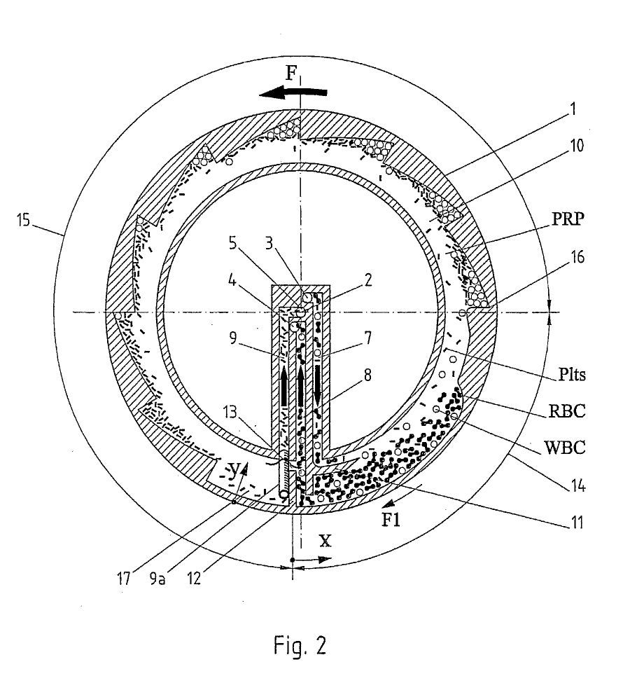

FIG. 2 shows a top view of a first embodiment;

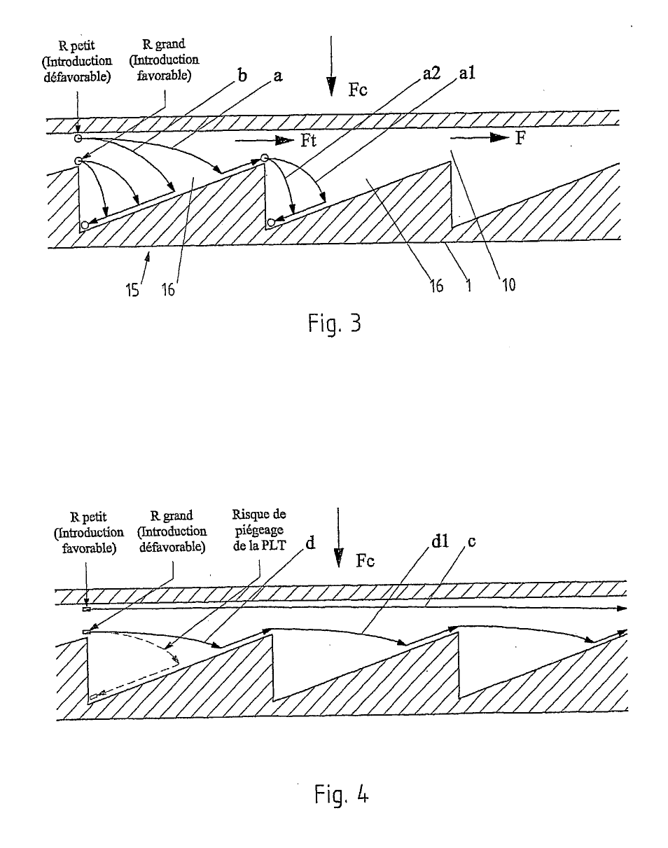

FIG. 3 shows a partial enlarged view to explain the ballistic effects on white blood cells, as used in the context of the invention;

FIG. 4 is a partial view similar to that of FIG. 2 showing the ballistic effects on the platelets, as used in the context of the invention;

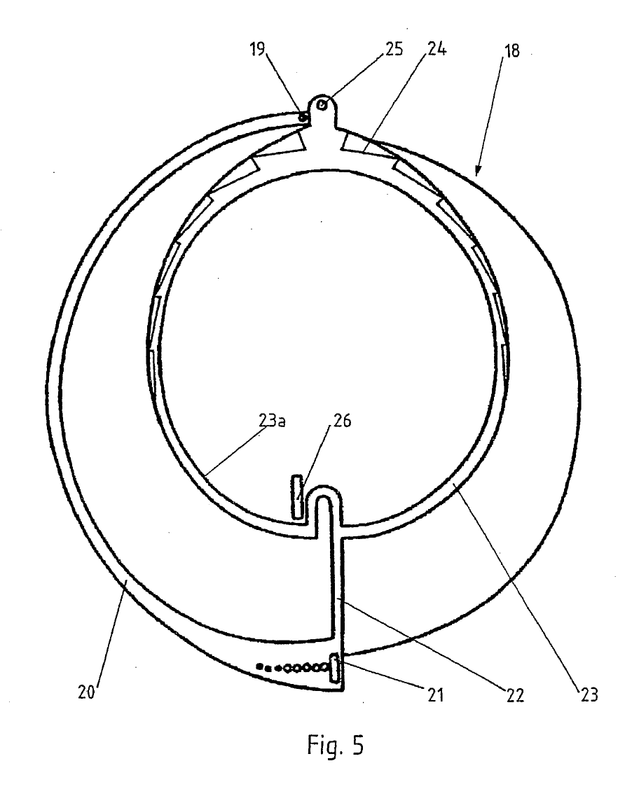

FIG. 5 is a top view of a further embodiment employing the principles of the invention;

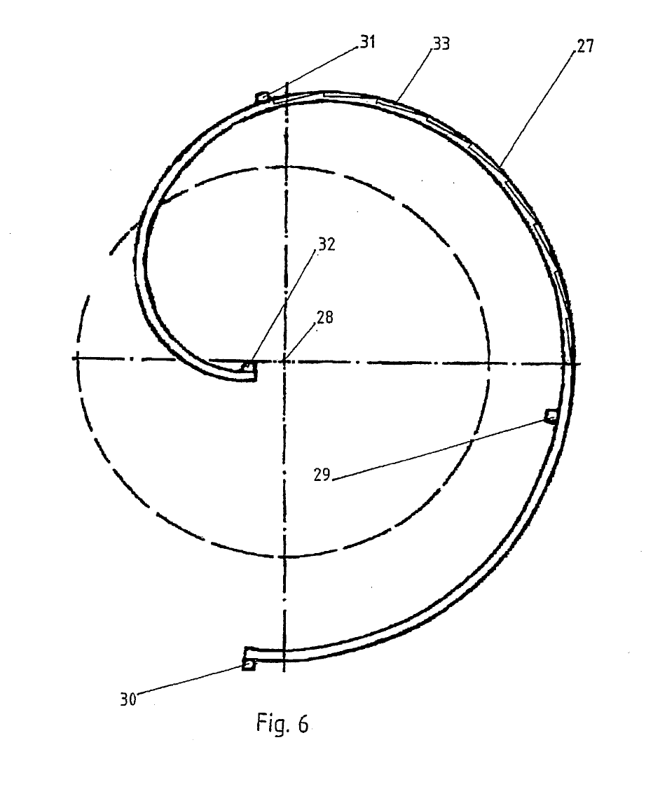

FIG. 6 is a top view of a further embodiment;

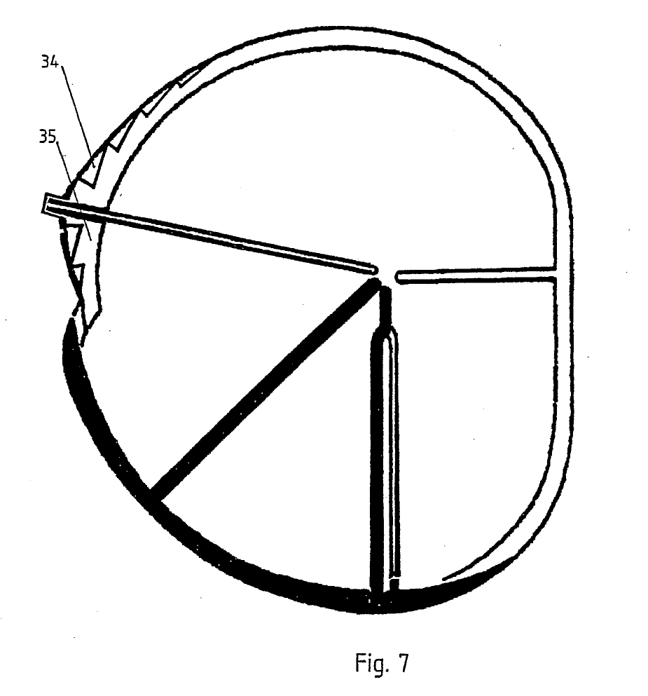

FIG. 7 is a top view of a final embodiment.

The centrifuge shown very diagrammatically in FIG. 1 on which the separation chamber 1 of the invention is used, is namely a disposable chamber preferably formed from a haemocompatible, transparent rigid plastic material, and comprises a motor M to cause the separation chamber to rotate about its axis of rotation 2. This separation chamber is connected to the exterior by at least three lines 3, 4, 5 connected to separation chamber 1 close to its axis of rotation 2. One of these lines, 3, is intended for connection to a donor via a peristaltic pump 6. A further line, 4, is intended to return blood from which platelets have been extracted to the donor, and the third line, 5, is intended to direct the platelets into a pouch which will be transfused into the recipient. Preferably, a single pump 6 ensures circulation in the various lines 3, 4, 5.

As can be seen in FIG. 2, the three lines 3, 4, 5 communicate with three radial channels 7, 8, 9 respectively, which open into a separation channel in the form of an annular chamber 10. Preferably, the cross section of this separation channel is rectangular, such that two opposing faces form the inner and outer lateral faces respectively of the separation channel and are parallel to the axis of rotation 2 of the separation chamber 1. Radial channel 7 opens into this annular chamber 10 close to its inner lateral face. A deflector 11 parallel to this inner lateral face, located at the outlet from radial channel 7 in annular chamber 10 and extending between the two other parallel faces, the upper and lower faces of separation channel 10 respectively, serves to impart a tangential velocity to the whole blood entering annular chamber 10. Radial channel 8 is adjacent to the radial channel 7 and opens close to the outer lateral face of annular chamber 10.

Finally, radial channel 9 is extended by a line 9a to near to the outer lateral face of annular chamber 10; a radial partition 12 extending radial channel 8 in annular chamber 10 separates the outlet for the red blood cells via radial channel 8 from that for platelets via radial channel 9. This radial partition 12 can also separate the two ends of the separation channel formed by annular chamber 10 so that the right hand side of this partition (FIG. 2) corresponds to the upstream end of this separation channel, while the left hand side of this partition constitutes the downstream end of this separation channel. A communication opening 13 adjacent to the inner lateral face of annular chamber 10 is provided through the radial partition 12 to allow plasma to be evacuated via the same radial channel 8 and thus via the same line 5 as the red blood cells.

Annular chamber 10 forming the blood separation channel comprises two portions arranged one after the other. The first portion 14 extends over about ¼ of the circumference starting from the point where the blood arrives via radial channel 7. This first portion 14 serves to separate the most dense particles, i.e., red blood cells RBC in their entirety, and a large proportion of the white blood cells WBC from platelet-rich plasma PRP, under the effect of the centrifugal force induced by rotating separation chamber 1 about its axis of rotation 2. As can be seen in FIG. 2, these particles are pressed against the outer lateral face of this portion 14 of annular chamber 10 and leave via radial channel 8 and line 4. These particles, the RBCs and a portion of the WBCs, thus flow in the direction of arrow F₁ into a portion 14 of annular chamber 10 adjacent to the outer lateral wall of this annular chamber 10, while the platelet-rich plasma PRP flows in the opposite direction of the second portion 15, in the direction of this annular chamber 10.

This second portion 15, which extends around approximately ¾ of annular chamber 10, serves to separate platelets Plt from plasma. Essentially, this second portion embodies the present invention. As has already been described, because of the substantial size difference between white blood cells and platelets, even though the densities of these particles are close, under the combined effect of the radial force due to centrifugal force and the tangential force due to the plasma flow, their trajectories differ very substantially from each other.

To exploit this feature, the outer lateral wall of the second portion 15 of annular chamber 10 comprises a succession of recesses 16 which in this example are approximately in the form of right angled triangles wherein one of the right angled sides is orientated radially with respect to the axis of rotation 2 of separation chamber 1 and wherein the second right angled side forms the opening into recess 16, while the hypotenuse connects the bottom of this recess 16, i.e., the portion that is radially furthest from the center of rotation 2 of separation chamber 1, to the radially orientated side of the next recess 16 in the direction F of flow of the platelet-rich plasma PRP in annular chamber 10. As a result, the radial distance between the side of recess 16 connecting its bottom to the edge of the next recess in the direction of flow F, decreases progressively from the bottom of this recess 16 to the edge of this next recess. It should be noted that the hypotenuse of the right-angled triangle formed by recesses 16 has a slightly concave curvature.

FIGS. 3 and 4 are intended to explain the ballistic principles on which the invention is based to enable white blood cells to be separated from platelets by successively trapping the white blood cells and storing these white blood cells which thus remain in separation chamber 1 once the separation process is complete and will be eliminated with this disposable separation chamber.

FIG. 3 shows a few recesses 16 of the portion 15 of annular chamber 10. This portion of the chamber is depicted as being straight rather than curved, but this fact is of no consequence as regards explaining the ballistics. Arrow Fc represents the direction of the centrifugal force applied to white blood cells WBC and Ft represents the direction of the tangential force applied to these same white blood cells.

Different trajectories are possible depending on the radial distance between the WBC particles and the center of rotation 2 of separation chamber 1, and also depending on the size of these particles. For a given rotational speed and a given particle mass, a parabolic path is imparted to the particles due to the laminar flow of the principal flow and the wall effect where the speeds are practically zero. FIG. 3 shows two extreme cases, one where the WBC particle is close to the inner lateral face of the annular chamber 10, the other where the WBC particle is close to the intersection between the radial face of a recess and the hypotenuse to the adjacent recess that constitutes the point on the outer lateral face of portion 15 of annular chamber 10 that is closest to the center of rotation 2. The case in which the WBC particles are closest to the inner lateral face of annular chamber 10 is least favourable to trapping these particles in the recesses. In this case, the smaller the particle, the lower its chance of being trapped.

Two trajectories are shown, a and b; trajectory a corresponds to the trajectory of the smallest WBC particles, while trajectory b corresponds to the trajectory of the largest WBC particles. It can be seen that with trajectory a, the WBC particle falls on the face of recess 16 corresponding to the hypotenuse at a relatively short distance from the intersection between this hypotenuse and the radial face of the next recess 16. By falling into this region, the WBC particle is subjected to two opposing forces, the centrifugal force Fc that tends to make it descend toward the bottom of recess 16 and the tangential force Ft that is imparted to it by the flow of the plasma in which it is suspended.

Assume that the tangential force Ft in this case is greater than the centrifugal force Fc. The WBC particle will be displaced toward the intersection between the hypotenuse of recess 16 with which it came into contact and the radial face of the next recess in the direction of plasma flow F. Given the particle size, the difference between the two opposing forces can only be relatively small. For this reason, as soon as this WBC particle leaves the slope formed by the hypotenuse of recess 16, it is subjected to two forces Fc and Ft. Given that it has lost a good proportion of its kinetic energy during its “climb” along the hypotenuse, the centrifugal force Fc will modify the trajectory of this particle compared with the initial trajectory a, shortening it, for example to trajectory a1 or trajectory a2.

As can then be seen, in both cases the particle falls onto a region of the hypotenuse of the next recess 16 where the plasma flow no longer has any practical influence thereon and the particle is only subjected to a centrifugal force, which causes it to “drop” toward the bottom of recess 16.

In the case of a larger particle represented by trajectory b, this trajectory is more influenced by the centrifugal force Fc, so that it is shorter and the particle falls onto the hypotenuse of recess 16 closer to the bottom of this recess, so that it has every chance of being sent to the bottom of this recess 16 by centrifugal force.

FIG. 4 shows the possible different trajectories for two platelets Plt entering the second portion 15 of the annular separation chamber at two radial distances from the center of rotation 2 of centrifugation chamber 1. Particle Plt that enters with the shortest radial distance follows a trajectory c where the radial distance from the center of rotation 2 increases very gradually. This is the most favourable case.

In the other case, the most unfavourable case, because of the parabolic path of the particles, the trajectory tends to shorten and, for example, it takes on the appearance of trajectory d that does not allow particle Plt to cover all of the angular extent of the opening to recess 16, so that it falls onto the hypotenuse of recess 16 in the form of a right angled triangle. Given that its size is smaller than that of the white blood cells following trajectory a illustrated in FIG. 3, the centrifugal force exerted on the particle Plt is smaller and it will decelerate the motion of this particle under the influence of the tangential force Ft to a lesser extent. As a result, on leaving the end of the slope formed by the hypotenuse to recess 16, adjacent to the radial face of the next recess in the direction F of plasma flow, the trajectory d1 will be longer than that a1 of the WBC particle of FIG. 3. This particle Plt could then jump from one recess 16 to the next in a succession of relatively long trajectories, almost to the last recesses 16 of portion 15 of annular chamber 10.

As can be seen in FIG. 2, the white blood cells WBC and the platelets Plt are separated, the white blood cells being trapped in the first recesses 16 while the platelets are trapped in the last recesses 16 in the direction of plasma flow F. It is clear that the first recesses 16 will be the first to be filled with white blood cells WBC, so that when one recess fills up, the surplus white blood cells will be driven toward the next recess 16, and so on. It can be seen that certain recesses 16 located in the median zone of the second portion 15 of annular chamber 10 contain both white blood cells WBC and platelets Plt. Given the difference in mass between platelets and white blood cells, these latter will pile up at the bottom, causing the platelets to “climb”or, more exactly, to displace them further toward the center of rotation 2.

Certain platelets may reach an evacuation compartment 17 of the separation chamber in which the outer lateral wall is circular and concentric with the axis of rotation 2 of separation chamber 1 in the direction in which they are impelled. These platelets then enter line 9a opening close to this outer lateral face of evacuation compartment 17. Platelets Plt that are trapped in recesses 16 of the second half of the second portion 15 of annular chamber 10, overflow from these recesses when they are full and pass successively from one recess 16 to the next until they reach evacuation compartment 17. Similarly, white blood cells WBC take the place of platelets Plt in recesses 16 where two particle types are found, so that the platelets are driven from recess to recess 16 until they reach evacuation compartment 17, where they are held by centrifugal force against the outer lateral wall of evacuation compartment 17 and directed by means of the plasma flow into the opening of line 9a extending channel 9 close to the outer lateral wall of compartment 17 where the platelets are concentrated.

Plasma, which has a lower density than platelets, is evacuated through the communication opening 13 via the red blood cell evacuation channel. This arrangement has the not insubstantial advantage of dispensing with a line that is unnecessary given that all of the blood constituents with the exception of the platelets are returned to the donor.

The proportions of recesses 16 must satisfy two criteria. One of these criteria is that the total volume of these recesses must be at least equal to the volume of the white blood cells to be separated from the plasma after separating the red blood cells and the major portion of the white blood cells in the first portion 14 of annular chamber 10. Considering a single session removing platelets from a donor, this volume is about 8 ml. The second criterion depends on the respective trajectories of white blood cells WBC and platelets Plt. These trajectories are a function of the centrifugal force Fc applied to the liquid to be separated and of the tangential force Ft, which is a function of the flow rate of the liquid in the annular chamber 10, itself a function of pressure of the blood fed via feed pump 6 and the pressure drops in the lines. When these parameters have been determined, the angular dimension of the opening of recesses 16 or that of the hypotenuse of the triangle formed by recess 16 can be selected, which in this case are the same.

As demonstrated in the foregoing description, while prior art separation systems are based on a static sedimentation principle, which is slow and of low selectivity because of the small difference in density between the particles to be separated, especially between white blood cells, platelets and plasma, the present invention utilizes the ballistics of trajectories induced by the centrifugal force and by the tangential force due to the plasma flow and is highly dependent on the particle size since the radius of the particles is squared in the sedimentation formula. The largest platelet size is 4 μm while that of the smallest white blood cells is 7 μm, so when the radii of these particles are squared, the multiplying factor between them is 3, thus providing centrifugation speeds that are at least three times higher while the difference in densities is only 0.03 kg/dm^{3.}

Thanks to the principle based on ballistics and the parabolic flow path employed in the present invention to separate particles with different sizes, the rate and separation selectivity of the particles are substantially improved compared with separators based on static principles. In the majority of known separation devices, the particles to be separated move along trajectories that are comparable with those shown in FIGS. 3 and 4 since the blood to be separated is subjected to a centrifugal force as it flows in a channel that is concave with respect to the center of rotation of that channel. As a result, the particles to be separated are also subjected to a tangential force due to the rate of flow and their respective trajectories are comparable with those shown in FIGS. 3 and 4. However, in the absence of traps provided along the outer lateral wall of the separation channel, the ballistic properties of the particles subjected to these forces cannot be exploited, and separation is solely based on density differences.

FIGS. 5-7 show how the principal features of the present invention can be utilised in known separation apparatus. The separation chamber 18 shown in FIG. 5, intended to be placed in a suitable centrifuge and formed from a rigid transparent plastic material, comprises an inlet 19 for whole blood that flows into a first separation channel 20 that extends over 180° and with outer and inner lateral walls with respective radial distances with respect to the center of rotation of separation chamber 18 that increase and decrease respectively on moving toward the end of this channel 20 opposite inlet 19. A line 21 serves to evacuate red blood cells, while a further line 22 connects the end of the inner lateral face of the first separation channel 20 to a second separation channel 23, and to a plasma evacuation line 26. A series of recesses 24 for trapping white blood cells is disposed between the inlet to channel 23 and an outlet opening 25 for evacuating platelets; the remaining plasma can return toward evacuation line 26 via the second half 23a of the second separation channel 23. White blood cells that are not separated with the red blood cells can thus be trapped in recess 24.

The variation illustrated in FIG. 6 shows a separation channel 27 in the form of a gradual spiral intended to be driven about an axis of rotation 28. An inlet 29 for whole blood is located along separation channel 27, an outlet 30 is located at the end of the spiral channel 27 that is radially furthest from the center of rotation 28 and can evacuate red blood cells. A second outlet 31 located between inlet 29 and the end that is radially closest to the axis of rotation 28 is intended to evacuate platelets. Finally, a third outlet 32, located at the end radially closest to the center of rotation 28, serves to evacuate plasma.

As shown in FIG. 6, a series of recesses 33 is provided on the outer lateral face of the spiral channel 27. These recesses 33 are triangular in shape, for example, like those in the preceding embodiments and also serve to trap the particles to be separated as a function of the trajectories of these particles connected to their respective volumes, as explained above.

FIG. 7 illustrates a final embodiment in which recesses 34 are provided on the outer lateral face of a channel 35 for separating platelets. These different examples show that the present invention can be applied to any blood separation chamber in which the blood circulates in a channel of generally concave shape with respect to the center of rotation of the separation chamber. As has been seen, this channel can have different forms, but the principle of the invention is applicable to each of the cases described. It is also applicable to other separation chambers based on principles similar to those described here.

While the invention has been described in relation to separation chambers that can separate platelets from whole blood, this invention is also applicable to separating platelets from platelet-rich plasma, red blood cells being separated independently using a distinct separator.

The separation chamber of the invention is more particularly, but not exclusively intended for continuous separation of de-leucocyted platelets.

1. Rotatable chamber for separating components with different densities and/or sizes from blood or platelet-rich plasma, comprising a channel (10, 23, 27) following a curve that is generally concave with respect to the axis of rotation (2, 28) of said chamber (1), alongside which are located an opening (7, 19, 29) for feeding blood or plasma and at least two openings (8, 9, 21, 25, 26, 30, 31, 32) for evacuating said separated components, means (P) for applying a tangential force to the blood or plasma to cause it to move from the feed opening (7, 19, 29) to the evacuation openings (8, 9, 21, 25, 26, 30, 31, 32) , and means (M) for driving said chamber (1) in rotation, in order to apply a radial force to the blood or plasma to be separated to cause said solid particles to sediment out against the outer lateral wall of said channel (10, 23, 27), characterized in that said outer lateral wall comprises a plurality of adjacent recesses (16, 24, 33, 34) that are successive in the direction (F) of flow of the blood or plasma to be separated, each having an angular extent that is determined as a function of the respective trajectories of said components, the radial distance between the lateral wall of each of said recesses and said axis of rotation (2, 28) progressively reducing in the direction of its downstream end.

2. Chamber according to claim 1, characterized in that the wall connecting the bottom of each recess (16, 24, 33) to its upstream end has an angular extent with respect to said axis of rotation of close to zero.

3. Chamber according to one of the preceding claims, characterized in that said channel (10) is circular in shape.

4. Chamber according to claim 3, characterized in that said opening (7) for feeding liquid to be separated and the opening (8) for evacuating the most dense particles are located close to the upstream end of said channel (10) , while the openings (9a, 13) for evacuating the least dense particles and plasma are located at the downstream end of said channel (10), close to the outer and inner lateral walls of said channel (10) respectively.

5. Chamber according to claim 4, characterized in that the opening (13) for evacuating plasma communicates with said opening (8) for evacuating the most dense particles.

6. Chamber according to any one of the preceding claims, characterized in that the total volume of said successive recesses (16, 24, 33) is selected to enable storage of at least a volume corresponding to the fraction of white blood cells contained in the volume of blood to be separated corresponding to the white blood cells subsisting in the platelet-rich plasma after separating the red blood cells.

7. Chamber according to any one of the preceding claims, characterized in that the cross section of said separation channel (10) is rectangular, its two inner and outer lateral faces being parallel to said axis of rotation (2), a radial deflector (11) parallel to the inner face of said separation channel (10) being disposed facing the feed opening (7) and extending between the two other parallel faces of said separation channel (10).
